(19) United States
(12) Patent Application Publication
(10) Pub. No.: US 2005/0176839 A1
(43) Pub. Date: Aug. 11, 2005

(54) Low density acoustic foams based on biopolymers

(76) Inventors: Huzeir Lekovic, Troy, MI (US); Rifat Tabakovic, Rochester Hills, MI (US); Ali J. El-Khatib, Dearborn, MI (US); Frank V. Billotto, Oakland Township, MI (US)

Correspondence Address: Richard W. Hoffmann, PO Box 70098, Rochester Hills, MI, 48307, US

(21) Appl. No.: 10/776,648

(22) Filed: Feb. 10, 2004

(51) Int. Cl. C08G 18/00

(52) U.S. Cl. 521/155

(57) ABSTRACT

Rigid polyurethane foams are described. The foams are made using a prepolymer that is the reaction product of at least one polyisocyanate component, at least one hydroxy-functional acrylate component, and at least one polyol component. The prepolymer is then reacted at specified volume ratios and isocyanate indices with at least one polyol component that includes at least one polyol that is a biopolymer, including but not limited to castor oil, soybean oil, and the like. The foam is made in the presence of at least one blowing agent and at least one catalyst.

### FIELD OF THE INVENTION

The present invention relates generally to rigid polyurethane foams, and more particularly to rigid polyurethane foams containing one or more hydrophobic biopolymers, such as but not limited to castor oil, soybean oil, and the like, that are particularly useful as low density acoustic foams for the automobile industry.

### BACKGROUND OF THE INVENTION

Rigid foams, especially polyurethane-based rigid foams, have been used in the automotive and other industries for a number of purposes. For example, these types of rigid foams have been used for structural reinforcement, noise abatement (e.g., for damping sound and vibration), and improved crash support. Low-density foams are especially suitable for use as acoustic foams. These foams have been used in headliners, doorframes, pillars, rocker panels, and other locations of automobiles in order to accomplish one or more of the aforementioned purposes.

Several problems exist with the manufacture and use of conventional rigid polyurethane foam compositions. One problem is the emissions of harmful chemicals, such as volatile organic compounds (VOC), especially isocyanate-containing compounds (e.g., MDI). Another problem is with water absorption by the rigid polyurethane foam over time. Other problems of conventional rigid polyurethane foam compositions include poor thermostability and processability (e.g., mixability and shelf life) characteristics.

Therefore, there exists a need for polyurethane compositions that can be used in rigid foam applications, wherein the foams exhibit decreased water absorption and VOC emission characteristics.

### SUMMARY OF THE INVENTION

In accordance with the general teachings of the present invention, a method for making a rigid polyurethane foam is provided, comprising mixing a polyisocyanate component with a polyol component in the presence of at least one catalyst for the reaction of a polyol or water with a polyisocyanate and subjecting the mixture to conditions sufficient to cause it to cure to form a polyurethane foam, wherein (a) the polyisocyanate component contains an isocyanate-terminated prepolymer made by reacting an excess of an organic polyisocyanate with (i) at least one polyol and (ii) at least one hydroxy-functional acrylate or methacrylate, (b) the polyol component containing an effective amount of a blowing agent and isocyanate-reactive materials that include at least one hydrophobic polyol selected from the group consisting of castor oil, soybean oil, and combinations thereof.

In accordance with one embodiment of the present invention, a method of making a rigid polyurethane foam is provided, comprising mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains an isocyanate-terminated prepolymer made by reacting an excess of an organic polyisocyanate with (i) at least one polyol and (ii) at least one hydroxy-functional acrylate, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

In accordance with a second embodiment of the present invention, a rigid polyurethane foam is provided, wherein the foam is formed by mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains an isocyanate-terminated prepolymer made by reacting an excess of an organic polyisocyanate with (i) at least one polyol and (ii) at least one hydroxy-functional acrylate, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

In accordance with a third embodiment of the present invention, a rigid polyurethane foam is provided, wherein the foam is formed by mixing a polyisocyanate component with a polyol component in the presence of at least one catalyst for the reaction of a polyol or water with a polyisocyanate and subjecting the mixture to conditions sufficient to cure to form a polyurethane foam having a bulk density in the range of about 2 to about 40 pounds per cubic foot, wherein (a) the polyisocyanate component contains an isocyanate-terminated prepolymer made by reacting an excess of an organic polyisocyanate with (i) at least one polyol and (ii) at least one hydroxy-functional acrylate, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1, wherein the volume ratio of the polyisocyanate component to polyol component is about 1:1.

In accordance with a fourth embodiment of the present invention, a method of making a rigid polyurethane foam is provided, comprising mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains at least one non-reactive hydrocarbon, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

In accordance with a fifth embodiment of the present invention, a rigid polyurethane foam is provided, wherein the foam is formed by mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains at least one non-reactive hydrocarbon, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

In accordance with a sixth embodiment of the present invention, a rigid polyurethane foam is provided, wherein the foam is formed by mixing a polyisocyanate component with a polyol component in the presence of at least one catalyst for the reaction of a polyol or water with a polyisocyanate and subjecting the mixture to conditions sufficient to cure to form a polyurethane foam having a bulk density in the range of about 2 to about 40 pounds per cubic foot, wherein (a) the polyisocyanate component contains at least one non-reactive hydrocarbon, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1, wherein the volume ratio of the polyisocyanate component to polyol component is about 1:1.

The present invention provides a method by which rigid polyurethane foam can be prepared at convenient mix ratios and at moderate operating temperatures while still allowing the formulation to cure quickly into good quality foam. The method and resulting foam of the present invention is especially suitable for making reinforcing foam, sound or vibration-dampening foam, and crash support foam, and is especially suitable for automotive applications.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The polyisocyanate component of the present invention preferably comprises an isocyanate-terminated prepolymer that is made from an excess of an organic polyisocyanate, a hydroxy-functional acrylate or methacrylate, and at least one polyol. The equivalent ratio of the hydroxy-functional acrylate or methacrylate to polyol is advantageously from about 0.5:1, preferably from about 0.75:1 and more preferably from about 1.25:1 to about 4:1, preferably about 3:1, even more preferably about 2:1.

The total number of equivalents of hydroxy-functional acrylate or methacrylate plus polyol(s) to the equivalents of starting organic polyisocyanate is advantageously such that the prepolymer has an isocyanate equivalent weight of from about 150, preferably from about 175, to about 500, preferably to about 350, more preferably to about 250, and still more preferably to about 170. These isocyanate equivalent weights correspond to NCO contents of from about 28-8.4%, preferably from 24-12%, more preferably from about 24-16.8%.

Suitable polyisocyanates that can be used in preparing the prepolymer include aromatic, aliphatic and cycloaliphatic polyisocyanates. Aromatic polyisocyanates are generally preferred based on cost, availability and properties, although aliphatic polyisocyanates are preferred in instances where stability to light is important. Exemplary polyisocyanates include, for example, m-phenylene diisocyanate, 2,4- and/or 2,6-toluene diisocyanate (TDI), the various isomers of diphenylmethanediisocyanate (MDI), hexamethylene-1,6-diisocyanate, tetra methylene-1,4-diisocyanate, cyclohexane-1,4-diisocyanate, hexahydrotoluene diisocyanate, hydrogenated MDI (H₁₂ MDI), naphthylene-1,5-diisocyanate, methoxyphenyl-2,4-diisocyanate, 4,4′-biphenylene diisocyanate, 3,3′-dimethyoxy-4,4′-biphenyl diisocyanate, 3,3′-dimethyldiphenylmethane-4,4-diisocyanate, 4,4′,4″-triphenylmethane diisocyanate, polymethylene polyphenylisocyanates, hydrogenated polymethylene polyphenylisocyanates, toluene-2,4,6-triisocyanate, and 4,4′-dimethyldiphenylmethane-2,2′,5,5′-t-etraisocyanate. Preferred polyisocyanates include TDI, MDI and the so-called polymeric MDI products, which are a mixture of polymethylene polyphenylene isocyanates in monomeric MDI. Especially suitable polymeric MDI products have a free MDI content of from about 5 to about 40% by weight, more preferably about 10 to about 25% by weight, and have an average functionality (number of isocyanate groups per molecule) of about 2.7 to 4.0, more preferably about 2.8 to about 3.4. Such polymeric MDI products are available from The Dow Chemical Company under the trade name PAPI.

Hydroxy-functional acrylates and methacrylates contain an acrylate (CH₂═CH—C(O)—) or methacrylate (CH₂═C(CH₃)—C(O)—) group and an isocyanate-reactive hydroxyl group. Suitable hydroxy-functional acrylates and methacrylates include 2-hydroxyethyl acrylate, 2-hydroxyethyl methacrylate (HEMA), 2-hydroxylpropyl acrylate, 2-hydroxypropyl methacrylate, 4-hydroxy-n-butyl acrylate, 2-hydroxy-n-butyl acrylate, 2-hydroxy-n-butyl methacrylate, 4-hydroxy-n-butyl methacrylate, poly(oxyethylene)- and/or poly(oxypropylene)-esters of acrylic or methacrylic acid, wherein the number of oxyethylene and/or oxypropylene groups is preferably from about 2 to about 10, and the like. Of the foregoing, the methacrylates are preferred, especially when the polyol component contains primary amine compounds. HEMA is especially preferred.

In accordance with a preferred embodiment of the present invention, it is preferred to use a polyol component that is comprised of at least one biopolymer. In accordance with another preferred embodiment of the present invention, the biopolymer is preferably hydrophobic. Examples of preferred biopolymers include, without limitation castor oil, soybean oil, and the like, including combinations thereof. In accordance with one embodiment of the present invention, the biopolymer may be present in an amount up to about 40 weight percent, based on the total weight of the polyol component of the present invention.

Additional polyol(s) useful in the present invention, and especially for making the isocyanate-terminated prepolymer, have an average at least about 2, advantageously about 2 to about 6, especially about 2 to about 3 and even more especially about 2 to about 2.5 hydroxyl groups per molecule (functionality). The equivalent weight per hydroxyl group can vary widely, so long as the prepolymer has the desired equivalent weight. The equivalent weight of each polyol may range from about 31 to 1500 or more, but is preferably below about 500, more preferably below about 300 and even more preferably about 200 or below.

Suitable polyols for use in making the isocyanate-terminated prepolymer include compounds such as alkylene glycols (e.g., ethylene glycol, propylene glycol, 1,4-butane diol, 1,6-hexanediol and the like), glycol ethers (such as diethylene glycol, triethylene glycol, dipropylene glycol, tripropylene glycol and the like), glycerine, trimethylolpropane, tertiary amine-containing polyols such as triethanolamine, triisopropanolamine, and ethylene oxide and/or propylene oxide adducts of ethylene diamine, toluene diamine and the like, polyether polyols, polyester polyols, and the like. Among the suitable polyether polyols are polymers of alkylene oxides such as ethylene oxide, propylene oxide and 1,2-butylene oxide or mixtures of such alkylene oxides. Preferred polyethers are polypropylene oxides or polymers of a mixture of propylene oxide and a small amount (up to about 12 weight percent) ethylene oxide. These preferred polyethers can be capped with up to about 30% by weight ethylene oxide.

Polyester polyols are also suitable in making the prepolymer. These polyester polyols include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols preferably have an equivalent weight of about 150 or less and include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like. Polycaprolactone polyols such as those sold by The Dow Chemical Company under the trade name TONE are also useful.

Preferred polyols for making the prepolymer are alkylene glycols, glycol ethers of up to about 75 equivalent weight, glycerine, trimethylolpropane, triethanolamine, triisopropanolamine, and poly(propylene oxide) polyols of up to about 200 equivalent weight.

The prepolymer is conveniently prepared by mixing the organic polyisocyanate, hydroxy-functional acrylate or methacrylate and polyol and subjecting the mixture to conditions such that the isocyanate and hydroxyl groups react to form the prepolymer. Generally, the reaction time is at least about 10 minutes to at most about 48 hours. The temperature of the mixing and reaction step may vary over a large range, but generally is limited so that reactants do not decompose, the acrylate or methacrylate groups do not polymerize to any significant extent and the reaction proceeds at a practicable rate. A preferred temperature is from about 20-75° C. The reactants are generally contacted under a dry atmosphere and preferably under nitrogen or other inert atmosphere. It is preferred to prepare the prepolymer in the absence of materials and conditions such as free radical initiators that promote the polymerization of the acrylate and/or methacrylate groups.

A catalyst may be and preferably is used in making the prepolymer. Suitable catalysts include those described by U.S. Pat. No. 4,390,645, incorporated herein by reference. Representative catalysts include: (a) tertiary amines, such as trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl) ether, morpholine,4,4′-(oxydi-2,1-ethanediyl)bis and triethylenediamine; (b) tertiary phosphines, such as trialkylphosphines and dialkylbenzylphosphines; (c) chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; (d) acidic metal salts of strong acids, such as ferric chloride, stannic chloride, stannous chloride, antimony trichloride, bismuth nitrate and bismuth chloride; (e) strong bases, such as alkali and alkaline earth metal hydroxides, alkoxides and phenoxides; (f) alcoholates and phenolates of various metals, such as Ti(OR)₄, Sn(OR)₄ and AI(OR)₃, wherein R is alkyl or aryl, and the reaction products of the alcoholates with carboxylic acids, beta-diketones and 2-(N,N-dialkylamino)alcohols; (g) salts of organic acids with a variety of metals, such as alkali metals, alkaline earth metals, Al, Sn, Pb, Mn, Co, Ni and Cu including, for example, sodium acetate, stannous octoate, stannous oleate, lead octoate, metallic driers, such as manganese and cobalt naphthenate; and (h) organometallic derivatives of tetravalent tin, trivalent and pentavalent As, Sb and Bi and metal carbonyls of iron and cobalt.

Catalysts are typically used in small amounts. For example, the total amount of catalyst used in making the prepolymer composition may be about 0.0015 to about 5, preferably from about 0.01 to about 1 percent by weight.

The isocyanate component may contain a plasticizer. The plasticizer may also be added after the prepolymer is made, or may be present during its formation. A plasticizer may perform several functions, such as reducing the prepolymer viscosity so it is easier to process and handle, modifying the rate of the foaming reaction, or softening or otherwise modifying the physical properties of the resulting polyurethane foam. The plasticizer is generally devoid of groups that react with the organic polyisocyanate, hydroxy-functional acrylate or methacrylate and polyol. Examples of plasticizers include phthalates (e.g., dioctyl phthalate, diisooctyl phthalate, dimethyl phthalate, dibutyl phthalate and mixtures of phthalates, such as those sold by BASF Corporation, Mt Olive, N.J., under the trade name PLATINOL (such as PLATINOL 79P)), phosphates (e.g., tributyl phosphate, triphenyl phosphate and cresyl diphenyl phosphate), chlorinated biphenyls, and aromatic oils such as VYCULT U-V (sold by Crowley Chemicals) and JAYFLEX L9P (sold by Exxon Chemicals). The amount of plasticizer, when employed, may range over a wide range depending on the foam properties desired. Generally, the plasticizer, when present, ranges from about 1 percent to at most about 50, preferably from about 15 to about 45 percent by weight of the polyisocyanate composition.

The prepolymer composition may also be made in the presence of a surfactant, such as those described by U.S. Pat. No. 4,390,645 incorporated by reference. The surfactant is typically used if desired to help compatibilize the other components used in making the prepolymer. In addition, the surfactant may be one that plays a beneficial role in forming foam from the prepolymer. Examples of surfactants include nonionic surfactants and wetting agents, such as those prepared by the sequential addition of propylene oxide and then ethylene oxide to propylene glycol, solid or liquid organosilicones, polyethylene glycol ethers of long chain alcohols, tertiary amine or alkylolamine salts of long chain alkyl acid sulfate esters, alkyl sulfonic esters and alkyl arylsulfonic acids. The surfactants prepared by the sequential addition of propylene oxide and then ethylene oxide to propylene glycol are preferred, as are the solid or liquid organosilicones. Non-hydrolyzable liquid organosilicones are more preferred. When a surfactant is used, it is typically present in an amount of about 0.0015 to about 1 percent by weight of the prepolymer component.

The fully formulated isocyanate component advantageously has an isocyanate equivalent weight of from about 150, preferably from about 175, to about 750, preferably to about 500, more preferably to about 400. The isocyanate functionality (exclusive of non-reactive materials such as plasticizers, surfactants and the like) is advantageously at least about 2.0, preferably at least 2.5, to about 4.0, preferably to about 3.5, more preferably to about 3.2 isocyanate groups/molecule on average.

The isocyanate component also preferably contains less than 25%, more preferably less than about 12%, especially 10% by weight or less of monomeric diisocyanates. By “monomeric diiisocyanates”, it is meant isocyanate compounds that do not contain urethane, urea, biuret or carbodiimide linkages, that have a molecular weight of 300 or less or which are otherwise formed in the reaction of two or more isocyanate-containing compounds. Having such low monomeric diisocyanate content substantially reduces the risks of polyisocyanate inhalation exposure; so costly engineering controls such as downdraft ventilation can be substantially reduced or potentially eliminated.

The polyol component preferably includes (i) a polyol or mixture of polyols and (ii) an effective amount of a blowing agent. The polyol component will most typically include a blend of two or more different polyols. The functionality (average number of isocyanate-reactive groups/molecule) of the polyol component (including polyols and amine-functional compounds as described below, but exclusive of non-isocyanate reactive materials, reactive catalysts as described below and water, if present) is at least about 2.3.

Suitable polyols are compounds having at least two isocyanate-reactive hydroxyl groups per molecule, provided that the polyol component has an average functionality of at least about 2.3, preferably at least about 2.5, to about 6.0, preferably to about 4.0. The functionality of the individual polyols preferably ranges from about 2 to about 12, more preferably from about 2 to about 8. As is discussed more fully below, mixtures of two or more polyols together with other isocyanate-reactive compounds are preferred. The hydroxyl equivalent weight of the individual polyols may range from about 31 to about 2000 or more. However, the equivalent weight of the polyol component as a whole is selected such that when the ratio of isocyanate groups in the polyisocyanate component to the number of isocyanate-reactive groups in the polyol component is from about 0.8:1 to about 1.5:1, the volume ratio of polyisocyanate to polyol component is no greater than 10:1. Preferably, the hydroxyl equivalent weight of the individual polyols is from about 31 to about 500, more preferably from about 31 to about 250, even more preferably from about 31 to about 200.

Among the suitable polyols are those described above with respect to the isocyanate-terminated prepolymer.

It is preferred that the polyol component includes at least a small amount of a tertiary amine-containing polyol and/or an amine-functional compound. The presence of these materials tends to increase the reactivity of the polyol component during the early stages of its reaction with the polyisocyanate component. This in turn helps the reaction mixture to build viscosity more quickly when first mixed and applied without unduly decreasing cream time, and thus reduces run-off or leakage.

Such tertiary amine-containing polyols include, for example, triisopropanol amine, triethanolamine and ethylene and/or propylene oxide adducts of ethylene diamine, toluene diamine or aminoethylpiperazine having a molecular weight of up to about 800, preferably up to about 400. When present, tertiary amine-containing polyols may constitute a minor or a major component of the polyol component. In this invention, a “major” or “main” amount or a “major” or “main” component is one constituting at least 50 weight percent of the polyol component as a whole. For example, the tertiary amine-containing polyol may constitute from about 1 to about 80% by weight of the polyol component.

The amine-functional compound is a compound having at least two isocyanate-reactive groups, of which at least one is a primary or secondary amine group. Among these are monoethanolamine, diethanolamine, monoisopropanol amine, diisopropanol amine and the like, and aliphatic polyamines such as aminoethylpiperazine. Also included among these compounds are the so-called aminated polyethers in which all or a portion of the hydroxyl groups of a polyether polyol is converted to primary or secondary amine groups. Suitable such aminated polyethers are sold by Huntsman Chemicals under the trade name JEFFAMINE. Typical conversions of hydroxyl to amine groups for these commercial materials range from about 70-95%, and thus these commercial products contain some residual hydroxyl groups in addition to the amine groups. Preferred among the aminated polyethers are those having a weight per isocyanate-reactive group of about 100-1700 daltons, especially about 100-250 daltons, and having 2-4 isocyanate-reactive groups per molecule.

These amine-functional compounds advantageously constitute no greater than about 10 weight percent, preferably from about 0.25 to about 7.5 weight percent of the total weight of the polyol component.

In order to impart toughness to the foam, aminor amount of a high (i.e. 800 or higher, preferably about 1500-3000) equivalent weight polyol may be added to the polyol component, as well. This high equivalent weight polyol is preferably a polyether polyol having two to three hydroxyl groups per molecule. It more preferably is a polypropylene oxide) that may be end-capped with up to 30% (by weight of the polyol) of poly(ethylene oxide). The high equivalent weight polyol may contain dispersed polymer particles. These materials are commercially known and are commonly referred to as “polymer polyols” (or, sometimes “copolymer polyols”). The dispersed polymer particles may be, for example, polymers of a vinyl monomer (such as styrene, acrylonitrile or styrene-acrylonitrile particles), polyurea particles or polyurethane particles. Polymer or copolymer polyols containing from about 2 to about 50% or more by weight dispersed polymer particles are suitable. When used, this polymer or copolymer polyol may constitute up to about 45%, preferably from about 5 to about 40%, of the weight of all isocyanate-reactive materials in the polyol component.

The polyol component also contains a blowing agent. Although physical blowing agents such as fluorocarbons, hydrofluorocarbons, chlorocarbons, chlorofluorocarbons and hydrochlorofluorocarbons can be used, the preferred blowing agents are chemical blowing agents that produce carbon dioxide during the foaming reaction. Among these chemical blowing agents are materials such as formate-blocked amines and water. The formate-blocked amines decompose under the foaming conditions to produce carbon dioxide. Water reacts with the polyisocyanate to form carbon dioxide gas that causes the reaction mixture to expand. The blowing agent is used in an amount sufficient to provide the foam with the aforementioned densities. When water is used as the blowing agent, about 0.5 to about 10, preferably from about 3 to about 8 parts by weight are used per 100 parts of polyol component.

Some preferred polyol mixtures for use in the polyol component include:

A. A mixture of a 2-3 functional non-amine-initiated polyether polyol of equivalent weight 200-500 as a main component, a 4-8 functional non-amine-initiated polyether polyol of equivalent weight of 250 or below, and an amine-initiated polyether polyol of equivalent weight of 200 or below. This may optionally contain up to about 10 weight percent (based on the total weight of the polyol component) of an amine-functional compound. The amine-functional compound is preferably an amine-terminated polyether.

B. A mixture of an amine-initiated polyether polyol of equivalent weight of 200 or below as a main component, up to about 10 weight percent (based on the total weight of the polyol component) of an amine-functional compound, and at least one 2-3 functional non-amine-initiated polyether polyol of equivalent weight 75-500. The amine-functional compound is preferably an amine-terminated polyether.

C. A 4-8 functional non-amine-initiated polyether polyol of equivalent weight of 250 or below as a main component, and an amine-functional compound of equivalent weight of 200 or below. The amine-functional compound is preferably an amine-terminated polyether. This formulation may also contain minor quantities (up to about 40% by weight of the polyol component) of least one 2-3 functional non-amine-initiated polyether polyol of equivalent weight 75-500.

All of these preferred polyol mixtures are preferably formulated into a polyol component that includes water and/or CO₂-producing chemical blowing agent and a reactive amine catalyst. Note that certain blocked amines, such as formic-acid blocked amine will perform the function of catalyzing the reaction as well as acting as a blowing agent through the generation of CO₂.

To form foam, the polyol component is mixed with the isocyanate component in the presence of a catalyst for the reaction of the polyol or water with an isocyanate. Most typically, this catalyst will be incorporated into the polyol component. Suitable catalysts are described above with respect to the making of the prepolymer. However, tertiary amine catalysts are preferred, and especially preferred are the so-called “reactive” amine catalysts that contain a hydroxyl or primary or secondary amine group that can react with an isocyanate to become chemically bonded into the foam. Among these especially preferred catalysts are N,N,N-trimethyl-N-hydroxyethyl-bis (aminoethyl) ether (available from Huntsman Chemical under the trade name ZF-10) and dimethyl 1-2 (2-aminoethoxy) ethanol (available from Nitrol-Europe under the trade name NP-70), and those sold by Air Products under the trade names DABCO 8154 and DABCO T.

The amount of catalyst is selected to provide a desired reaction rate. The amount that is used will depend somewhat on the particular catalyst. Generally, the amounts described before with respect to the making of the prepolymer are suitable. However, when the preferred reactive amine catalysts are used, somewhat greater amounts can be used. For these reactive amine catalysts, the amount used preferably ranges from about 1 to about 15, more preferably from about 2 to about 13 percent of the total weight of the polyol component.

In addition, the polyol component and/or the prepolymer component can contain various auxiliary components as may be useful in making a rigid foam, such as surfactants, fillers, colorants, odor masks, flame retardants, biocides, antioxidants, UV stabilizers, antistatic agents, thixotropic agents and cell openers.

Suitable surfactants include commercially available polysiloxane/polyether copolymers such as TEGOSTAB (trademark of Degussa) B-8462 and B-8404, and DC-198 and DC-5043 surfactants, available from Dow Corning.

Examples of suitable flame-retardants include phosphorous compounds, halogen-containing compounds and melamine.

Examples of fillers and pigments include calcium carbonate, titanium dioxide, iron oxide, chromium oxide, azo/diazo dyes, phthalocyanines, dioxazines and carbon black.

Examples of UV stabilizers include hydroxybenzotriazoles, zinc dibutyl thiocarbamate, 2,6-ditertiarybutyl catechol, hydroxybenzophenones, hindered amines and phosphites.

Examples of cell openers include silicon-based antifoamers, waxes, finely divided solids, liquid perfluorocarbons, paraffin oils and long chain fatty acids.

The foregoing additives are generally used in small amounts, such as from about 0.01 percent to about 1 percent by weight of the polyisocyanate component.

Foam according to the invention is prepared by mixing the polyol and polyisocyanate components and allowing the reactants to react and form a foam. Although this invention is not limited to any theory, it is believed that as the prepolymer reacts with the polyol component, the heat that is released causes the acrylate and/or methacrylate groups to polymerize, thus forming bridges between the prepolymer molecules and contributing to the overall network of the polymer in the cured foam. An advantage of this invention is that the reaction proceeds rapidly when the components are mixed at ambient to moderately elevated temperatures, such as from about 20 to about 70° C., preferably from about 35-65° C. This simplifies handling and applying the foam. Another advantage of the invention is that because of the low volume ratios of the polyol and isocyanate components, a variety of commonly available mixing and dispensing equipment can be used. In the applications of particular interest, the mixed isocyanate and polyol components are dispensed onto a part or assemblage where localized reinforcement, corrosion protection, sound insulation or vibration dampening is desired. The formulation then cures in place, generally without the further application of additional heat or energy for curing, although heating can be used if desired to speed the cure. Alternately, the foam can be formed separately and then glued or otherwise attached to the structural member. It is usually not necessary to apply heat to effect a full expansion and cure.

In accordance with a highly preferred embodiment of the present invention, the isocyanate index is preferably less than 1. That is, it is preferred that an excess of functional hydroxyl groups, as compared to the amount of functional isocyanate groups, are present during the formation of the foams of the present invention.

By way of a non-limiting example, in making the foam of the present invention, the ratios of the two components (i.e., isocyanate and polyol) are advantageously selected so as to provide an isocyanate index (ratio of NCO to isocyanate-reactive groups (e.g., OH)) of about 0.5, preferably about 0.6, more preferably about 0.7, still more preferably about 0.8, still yet more preferably about 0.9, and most preferably about less than 1.0. It should be appreciated that isocyanate indices outside of these ranges may be used as well.

The polyol component and the isocyanate component are mixed in a volume ratio of less than 10:1, preferably from about 1:2 to 8:1, more preferably about 1:1.5 to 6:1, even more preferably from about 1:1 to 4:1. The density of the product foam is preferably is preferably in the range of about 2 to about 40 pounds per cubic foot (pcf), more preferably about 10 pcf, still more preferably about 5 pcf, and most preferably about 3 pcf.

The foams of the present invention are especially suitable for use in automotive applications, and thus are especially suitable for use with automotive components, or alternatively, can be shaped for use as automotive components.

The following examples are provided to illustrate the invention, but are not intended to limit the scope thereof. All parts and percentages are by weight unless otherwise indicated.

The following materials in Table IA were used in the following examples to form the prepolymer components of the present invention. However, it should be appreciated that additional materials may be used to manufacture the prepolymer components of the present invention, as described herein.

TABLE IA

| Material | Description | Supplier |
|---|---|---|
| HEMA | Hydrophilic acrylate | Sigma |
| | (2-hydroxy-ethyl- | (St. Louis, Missouri) |
| | methacrylate) | |
| PLATINOL 79P | Plasticizer (1,2- | BASF |
| | benzene dicarboxylic | (Mount Olive, New |
| | acid) | Jersey) |
| PAPI 20 | Polymeric MDI | Dow Chemical |
| | (Polymethylene | (Midland, Michigan) |
| | polyphenyl | |
| | isocyanate | |
| | containing 4,4 | |
| | methylene bisphenyl | |
| | isocyanate) | |
| Polyglycol E-400 | Polyether polyol | Dow Chemical |
| | (polyethylene glycol) | (Midland, Michigan) |
| PAROIL 45 | Liquid Medium Chain | Dover Chemical |
| | Chlorinated Paraffin | (Dover, Ohio) |

The following materials in Table IB were used in the following examples to form the polyol components of the present invention. However, it should be appreciated that additional materials may be used to manufacture the polyol components of the present invention, as described herein.

TABLE IB

| Material | Description | Supplier |
|---|---|---|
| SPECFLEX NC 700 | Polyether polyol containing | Dow Chemical (Midland, |
| | copolymerized styrene and | Michigan) |
| | acrylonitrile | |
| CASTOR OIL | Biopolymer (castor oil) | Alnor Oil (Valley Stream, |
| | comprised of an ester of | New York) |
| | fatty acids and glycerol | |
| DABCO 33 LV | Mixture of | Air Products (Allentown, |
| | triethylenediamine and | Pennsylvania) |
| | dipropylene glycol | |
| JEFFAMINE T-403 | Polyether triamine curing agent | Huntsman Chemical |
| | | (Houston, Texas) |
| SPI 847 | Bis (2-dimetlylamino | Specialty Chemical |
| | ethyl) ether tertiary amine | Products (Macungie, |
| | | Pennsylvania) |
| TEGOSTAB B 8404 | Polysilicone | Degussa (Dusseldorf, |
| | | Germany) |
| TEGOSTAB B 8870 | Polysilicone | Degussa (Dusseldorf, |
| | | Germany) |
| SOYOIL P38N | Biopolymer (soybean oil) | Urethane Soy Systems |
| | comprised of an ester of | (Princeton, Illinois) |
| | fatty acids and glycerol | |
| POLYG 76-120 | Polyether triol (glycerol | Arch Chemicals (Norwalk, |
| | based polyol) | Connecticut) |
| JEFFAMINE D-400 | Epoxy curing agent | Huntsman Chemical |
| | | (Houston, Texas) |
| WATER | Blowing agent and active | Dow Chemical |
| | hydrogen compound | (Midland, Michigan) |
| POLYCAT 9 | Tertiary amine catalyst | Air Products (Allentown, |
| | | Pennsylvania) |
| JEFFAMINE T-5000 | Polyether triamine | Huntsman Chemical |
| | | (Houston, Texas) |
| TEGOSTAB B4113 | Silicone oil | Degussa (Dusseldorf, |
| | | Germany) |
| DABCO DC-198 | Silicone surfactant | Air Products (Allentown, |
| | | Pennsylvania) |
| VORANOL 391 | Polyether aromatic amine | Dow Chemical (Midland, |
| | polyol | Michigan) |
| BENZOIL CHLORIDE | Stabilizer | Gwalior (Bombay, India) |
| JEFFOL A-480 | Amine polyol | Huntsman Chemical |
| | | (Houston, Texas) |

The prepolymer formulation for foam formula 1 is set forth in Table II, below:

TABLE II

| | | Equivalent | | | | | |
|---|---|---|---|---|---|---|---|
| Raw Material | Wt. % | Weight | Equivalency | F | Moles | Gm/cc | Grams |
| HEMA | 4.7 | 131 | 0.04 | 1 | 0.03588 | 1.070 | 47 |
| PEG 400 | 1.88 | 200 | 0.00940 | 2 | 0.0047 | 1.120 | 18.8 |
| PLATINOL 79 P | 25 | — | — | — | — | 0.976 | 250 |
| PAPI 20 | 68.37 | 141 | 0.48489 | 3.2 | 0.15153 | 1.234 | 683.7 |
| BENZOYL | 0.05 | — | — | — | — | 1 | 0.5 |
| CHLORIDE | | | | | | | |

The prepolymer equivalent weight was 170, wherein the NCO percentage was 24.65.

The foam formulations, including the isocyanate component and the polyol component for foam formula 1, are set forth in Tables III and IV, respectively, below:

TABLE III

| | | | | | | Equiv- |
|---|---|---|---|---|---|---|
| Raw | | | Wt. | | | alent |
| Material | Functionality | Moles | % | Grams | gm/cc | Weight |
| Prepolymer | 2.99 | 0.1468 | 100 | 1000 | 1.148 | 227 |

TABLE IV

| | Func- | | | | | Eq. |
|---|---|---|---|---|---|---|
| Raw Material | tionality | Moles | Wt. % | Grams | gm/cc | Wt |
| SPECFLEX NC | 3 | 0.0057 | 47.5 | 190 | 1.097 | 2777 |
| 700 | | | | | | |
| CASTOR OIL | 2.7 | 0.0218 | 20 | 80 | 0.958 | 340 |
| DABCO 33LV | 1 | 0 | 1 | 4 | 1.03 | NA |
| JEFFAMINE T- | 3 | 0.0064 | 3 | 12 | 0.981 | 156 |
| 403 | | | | | | |
| SPI 847 | 1 | 0 | 1.5 | 6 | 0.85 | NA |
| B 8404 | 1 | 0 | 1.5 | 6 | 1.049 | NA |
| SOYOIL P38N | 1.8 | 0.0097 | 19 | 76 | 0.98 | 1083 |
| WATER | 2 | 0.3611 | 6.5 | 26 | 1 | 9 |

The foam equivalent weight was 227, wherein the NCO percentage was only 18.47.

The prepolymer formulation for foam formula 2 is set forth in Table V, below:

TABLE V

| Raw | | Equivalent | | | | | |
|---|---|---|---|---|---|---|---|
| Material | Wt. % | Weight | Equivalency | Functionality | Moles | Gm/cc | Grams |
| HEMA | 4.7 | 131 | 0.03588 | 1 | 0.03588 | 1.07 | 47 |
| PEG 400 | 1.88 | 200 | 0.00940 | 2 | 0.0047 | 1.12 | 18.8 |
| PLATINOL | 25 | — | — | — | — | 0.976 | 250 |
| 79 P | | | | | | | |
| PAPI 20 | 68.37 | 141 | 0.48489 | 3.2 | 0.15153 | 1.234 | 683.7 |
| BENZOYL | 0.05 | — | — | — | — | 1 | 0.5 |
| CHLORIDE | | | | | | | |

The prepolymer equivalent weight was 170, wherein the NCO percentage was 24.65.

The foam formulations, including the isocyanate component and the polyol component, for foam formula 2 are set forth in Tables VI and VII, respectively, below:

TABLE VI

| Raw | Func- | | | | | Equivalent |
|---|---|---|---|---|---|---|
| Material | tionality | Moles | Wt. % | Grams | gm/cc | Weight |
| Prepolymer | 2.990 | 0.1468 | 100 | 1000 | 1.148 | 227 |

TABLE VII

| | | | | | | Equiv- |
|---|---|---|---|---|---|---|
| | Func- | | Wt. | | | alent |
| Raw Material | tionality | Moles | % | Grams | gm/cc | Weight |
| SPECFLEX NC | 3 | 0.0060 | 49.7 | 198.8 | 1.097 | 2777 |
| 700 | | | | | | |
| CASTOR OIL | 2.7 | 0.0218 | 20 | 80 | 0.958 | 340 |
| DABCO 33LV | 1 | 0 | 1 | 4 | 1.03 | NA |
| JEFFAMINE T- | 3 | 0.0064 | 3 | 12 | 0.981 | 156 |
| 403 | | | | | | |
| SPI 847 | 1 | 0 | 1.5 | 6 | 0.85 | NA |
| B 8404 | 1 | 0 | 1.5 | 6 | 1.049 | NA |
| SOYOIL P38N | 1.8 | 0.0097 | 19 | 76 | 0.98 | 1083 |
| WATER | 2 | 0.2389 | 4.3 | 17.2 | 1 | 9 |

The foam equivalent weight was 227, wherein the NCO percentage was only 18.47.

The prepolymer formulation for foam formula 3 is set forth in Table VIII, below:

TABLE VIII

| | | Equivalent | | | | | |
|---|---|---|---|---|---|---|---|
| Raw Material | Wt. % | Weight | Equivalent | Functionality | Moles | gm/cc | Grams |
| HEMA | 4.7 | 131 | 0.03588 | 1 | 0.03588 | 1.07 | 47 |
| PEG 400 | 1.88 | 200 | 0.00940 | 2 | 0.0047 | 1.12 | 18.8 |
| PLATINOL | 25 | — | — | — | — | 0.976 | 250 |
| 79 P | | | | | | | |
| PAPI 20 | 68.37 | 141 | 0.48489 | 3.2 | 0.15153 | 1.234 | 683.7 |
| BENZOYL | 0.05 | — | — | — | — | 1 | 0.5 |
| CHLORIDE | | | | | | | |

The foam formulations, including the isocyanate component and the polyol component, for foam formula 3 are set forth in Tables IX and X, respectively, below:

TABLE IX

| Raw | Func- | | | | | Equivalent |
|---|---|---|---|---|---|---|
| Material | tionality | Moles | Wt. % | Grams | Gm/cc | Weight |
| Prepolymer | 2.990 | 0.1468 | 100 | 1000 | 1.148 | 227 |

TABLE X

| | | | | | | Equiv- |
|---|---|---|---|---|---|---|
| | Func- | | Wt. | | | alent |
| Raw Material | tionality | Moles | % | Grams | gm/cc | Weight |
| SPECFLEX NC | 3 | 0.0058 | 48.5 | 194 | 1.097 | 2777 |
| 700 | | | | | | |
| CASTOR OIL | 2.7 | 0.0218 | 20 | 80 | 0.958 | 340 |
| DABCO 33LV | 1 | 0 | 1 | 4 | 1.03 | NA |
| JEFFAMINE T- | 3 | 0.0064 | 3 | 12 | 0.981 | 156 |
| 403 | | | | | | |
| SPI 847 | 1 | 0 | 1.5 | 6 | 0.85 | NA |
| B 8404 | 1 | 0 | 1.5 | 6 | 1.049 | NA |
| SOYOIL P38N | 1.8 | 0.0097 | 19 | 76 | 0.98 | 1083 |
| WATER | 2 | 0.3056 | 5.5 | 22 | 1 | 9 |

The prepolymer formulation for foam formula 4 is set forth in Table XI, below:

TABLE XI

| Raw | | Equivalent | | | | | |
|---|---|---|---|---|---|---|---|
| Material | Wt. % | Weight | Equivalency | Functionality | Moles | gm/cc | Grams |
| HEMA | 4.7 | 131 | 0.03588 | 1 | 0.03588 | 1.07 | 47 |
| PEG 400 | 1.88 | 200 | 0.00940 | 2 | 0.00470 | 1.025 | 18.8 |
| PLATINOL | 25 | — | — | — | — | 0.976 | 250 |
| 79 P | | | | | | | |
| PAPI 20 | 68.37 | 141 | 0.48489 | 3.2 | 0.15153 | 1.234 | 683.7 |
| BENZOYL | 0.05 | — | — | — | — | 1 | 0.5 |
| CHLORIDE | | | | | | | |

The prepolymer equivalent weight was 170, wherein the NCO percentage was 24.65.

The foam formulations, including the isocyanate component and the polyol component, for foam formula 3 are set forth in Tables XII and XIII, respectively, below:

TABLE XII

| Raw | | | Wt. | | gm/ | Equivalent |
|---|---|---|---|---|---|---|
| Material | Functionality | Moles | % | Grams | cc | Weight |
| Prepolymer | 2.990 | 0.1468 | 100 | 1000 | 1.133 | 227 |

TABLE XIII

| Raw | Func- | | Wt. | | | Equivalent |
|---|---|---|---|---|---|---|
| Material | tionality | Moles | % | Grams | gm/cc | Weight |
| SPECFLEX | 3 | 0.0101 | 84 | 336 | 1.097 | 2777 |
| NC 700 | | | | | | |
| POLYCAT 9 | 1 | 0 | 1.5 | 6 | 1.049 | NA |
| SPI 847 | 1 | 0 | 1.5 | 6 | 0.87 | NA |
| B 4113 | 1 | 0 | 0.35 | 1.40 | 1 | NA |
| DC-198 | 1 | 0 | 0.35 | 1.40 | 9 | NA |
| D-400 | 2 | 0.0213 | 8.5 | 34 | 1.045 | 200 |
| WATER | 2 | 0.2111 | 3.8 | 15.20 | 1 | 9 |

The foam equivalent weight was 227, wherein the NCO percentage was only 18.47.

The prepolymer formulation for foam formula 5 is set forth in Table XIV, below:

TABLE XIV

| Raw | | Equivalent | | | | | |
|---|---|---|---|---|---|---|---|
| Material | Wt. % | Weight | Equivalency | Functionality | Moles | gm/cc | Grams |
| HEMA | 4.7 | 131 | 0.03588 | 1 | 0.03588 | 1.07 | 1692 |
| PEG 400 | 1.88 | 200 | 0.0094 | 2 | 0.0047 | 1.025 | 676.8 |
| PLATINOL | 25 | — | — | — | — | 0.976 | 9000 |
| 79 P | | | | | | | |
| PAPI 20 | 68.37 | 141 | 0.48489 | 3.2 | 0.15153 | 1.234 | 24613.2 |
| BENZOYL | 0.05 | — | — | — | — | 1 | 18 |
| CHLORIDE | | | | | | | |

The prepolymer equivalent weight was 170, wherein the NCO percentage was 24.65.

The foam formulations, including the isocyanate component and the polyol component, for foam formula 5 are set forth in Tables XV and XVI, respectively, below:

TABLE XV

| Raw | Func- | | | | | Equivalent |
|---|---|---|---|---|---|---|
| Material | tionality | Moles | Wt. % | Grams | gm/cc | Weight |
| Prepolymer | 2.99 | 0.1468 | 100 | 1000 | 1.133 | 227 |

TABLE XVI

| Raw | Func- | | | | | Equivalent |
|---|---|---|---|---|---|---|
| Material | tionality | Moles | Wt. % | Grams | gm/cc | Weight |
| SPECFLEX | 3 | 0.0081 | 67.2 | 12096 | 1.097 | 2777 |
| NC 700 | | | | | | |
| VORANOL | 4 | 0.0052 | 3 | 540 | 1.052 | 143.7 |
| 391 | | | | | | |
| POLYCAT 9 | 1 | 0 | 1.5 | 270 | 0.87 | NA |
| T-5000 | 3 | 0.0013 | 6.5 | 1170 | 0.81 | 1666.66 |
| SPI 847 | 1 | 0 | 1.5 | 270 | 0.87 | NA |
| B 8870 | 1 | 0 | 0.5 | 90 | 1 | NA |
| PG 76-120 | 3 | 0.0071 | 10 | 1800 | 1.032 | 467.5 |
| DA-400 | 1 | 0.025 | 5 | 900 | 0.978 | 200 |
| WATER | 2 | 0.2667 | 4.8 | 864 | 1 | 9 |

The foam equivalent weight was 227, wherein the NCO percentage was only 18.47.

The prepolymer formulation for foam formula 6 is set forth in Table XVII, below:

TABLE XVII

| Raw | | Equivalent | | | | | |
|---|---|---|---|---|---|---|---|
| Material | Wt. % | Weight | Equivalency | Functionality | Moles | gm/cc | Grams |
| HEMA | 4.7 | 131 | 0.03588 | 1 | 0.03588 | 1.07 | 47 |
| PEG 400 | 1.88 | 200 | 0.0094 | 2 | 0.0047 | 1.025 | 18.8 |
| PLATINOL | 25 | — | — | — | — | 0.976 | 250 |
| 79 P | | | | | | | |
| PAPI 20 | 68.37 | 141 | 0.48489 | 3.200 | 0.15153 | 1.234 | 683.7 |
| BENZOYL | 0.050 | — | — | — | — | 1 | 0.5 |
| CHLORIDE | | | | | | | |

The prepolymer equivalent weight was 170, wherein the NCO percentage was 24.65.

The foam formulations, including the isocyanate component and the polyol component, for foam formula 6 are set forth in Tables XVIII and XIX, respectively, below:

TABLE XVIII

| Raw | Func- | | | | | Equivalent |
|---|---|---|---|---|---|---|
| Material | tionality | Moles | Wt. % | Grams | gm/cc | Weight |
| Prepolymer | 2.99 | 0.1468 | 100 | 1000 | 1.133 | 227 |

TABLE XIX

| Raw | Func- | | | | | Equivalent |
|---|---|---|---|---|---|---|
| Material | tionality | Moles | Wt. % | Grams | gm/cc | Weight |
| SPECFLEX | 3 | 0.0081 | 67.15 | 268.60 | 1.097 | 2777 |
| NC 700 | | | | | | |
| VORANOL | 4 | 0.0043 | 2.5 | 10 | 1.052 | 143.7 |
| 391 | | | | | | |
| POLYCAT 9 | 1 | 0 | 1.5 | 6 | 1.049 | NA |
| JEFFAMINE | 3 | 0.0013 | 6.5 | 26 | 0.81 | 1666.66 |
| T-5000 | | | | | | |
| SPI 847 | 1 | 0 | 1.5 | 6 | 0.87 | NA |
| B 4113 | 1 | 0 | 0.7 | 2.80 | 1 | NA |
| PG 76-120 | 3 | 0.0071 | 10 | 40 | 1.032 | 467.5 |
| DC-198 | 1 | 0 | 0.35 | 1.40 | 0.9 | NA |
| D-400 | 2 | 0.0125 | 5 | 20 | 1.045 | 200 |
| WATER | 2 | 0.2667 | 4.8 | 19.20 | 1 | 9 |

The foam equivalent weight was 227, wherein the NCO percentage was only 18.47.

In accordance with another aspect of the present invention, a diluted isocyanate polymer mixture including a polyisocyanate (e.g., PAPI 20) and at least one non-reactive hydrocarbon is preferably provided. That is, the hydrocarbon preferably does not react with the polyisocyanate. By way of a non-limiting example, the hydrocarbon is preferably a wax or wax-like material, more preferably paraffin, still more preferably chlorinated paraffin, and most preferably a liquid chlorinated paraffin readily commercially available under the trade name PAROIL 45 (Dover Chemical, Dover, Ohio). The isocyanate formulation for foam formula 7 is set forth in Table XX, below:

TABLE XX

| Raw | | Equivalent | | | | | |
|---|---|---|---|---|---|---|---|
| Material | Wt. % | Weight | Equivalency | Functionality | Moles | gm/cc | Grams |
| PAPI 20 | 65 | 141 | 0.48489 | 3.200 | 0.14406 | 1.234 | 260.00 |
| PAROIL 45 | 35 | — | — | — | — | 0.970 | 140.00 |

The foam formulations, including the isocyanate component and the polyol component, for foam formula 7 are set forth in Tables XXI and XXII, respectively, below:

TABLE XXI

| Raw | Func- | | | | | Equivalent |
|---|---|---|---|---|---|---|
| Material | tionality | Moles | Wt. % | Grams | gm/cc | Weight |
| Isocyanate | 3.21 | 0.1433 | 100 | 1000 | 1.126 | 218 |
| Component | | | | | | |

TABLE XXII

| | | | | | | Equiva- |
|---|---|---|---|---|---|---|
| Raw | Function- | | | | | lent |
| Material | ality | Moles | Wt. % | Grams | gm/cc | Weight |
| SPECFLEX | 3 | 0.0071 | 56.25 | 562.50 | 1.097 | 2640 |
| NC 700 | | | | | | |
| Castor Oil | 2.7 | 0.0218 | 20 | 200 | 0.958 | 340 |
| POLYCAT 9 | 1 | 0 | 2 | 20 | 1.049 | NA |
| JEFFOL | 4 | 0.0314 | 15 | 150 | 1.010 | 119.36 |
| A-480 | | | | | | |
| SPI 847 | 1 | 0 | 1 | 10 | 1.012 | NA |
| TEGOSTAB | 2 | 0.0003 | 0.25 | 2.5 | 1.045 | 465 |
| B 8404 | | | | | | |
| WATER | 2 | 0.3056 | 5.5 | 55 | 1 | 9 |

The foam equivalent weight was 218, wherein the NCO percentage was only 19.30.

The water absorption characteristics of the foams produced in accordance with each of the foregoing formulas was then determined. The resulting foams were placed in a humidity chamber, operating at 38° C. and 100% relative humidity, for a period of ten days. The foams were then removed from the humidity chamber and tested at various time intervals to determine the amount of water weight absorbed (total weight of the foam sample is shown) and the percentage of water absorbance post-exposure.

The results for foam formula 1 are set forth in Table XXI II, below:

TABLE XXIII

| | Pre- | Wt. | Wt. | Wt. | | | |
|---|---|---|---|---|---|---|---|
| | exp. | (gms) | (gms) | (gms) | 0 hrs | 8 hrs | 24 hrs |
| | Foam | 0 hrs | 8 hrs | 24 hrs | after | after | after |
| | Wt. | after | after | after | exp. | exp. | exp. |
| Sample | (gms) | exp. | exp. | exp. | (% abs) | (% abs) | (% abs) |
| 1 | 139.9 | 211.5 | 198.9 | 193.9 | 51.18 | 42.17 | 38.60 |
| 2 | 138.9 | 177.1 | 166.9 | 163.7 | 27.50 | 20.16 | 17.82 |
| 3 | 138.2 | 185.3 | 174.4 | 169.7 | 34.08 | 26.19 | 22.79 |
| 4 | 138 | 170.4 | 160.7 | 156.8 | 23.48 | 16.45 | 13.62 |
| 5 | 138.6 | 176.5 | 165 | 161.3 | 27.34 | 19.05 | 16.38 |

The results for foam formula 2 are set forth in Table XXIV, below:

TABLE XXIV

| | | Wt. | Wt. | Wt. | | | |
|---|---|---|---|---|---|---|---|
| | Pre- | (gms) | (gms) | (gms) | 0 hrs | 8 hrs | 24 hrs |
| | exp. | 0 hrs | 8 hrs | 24 hrs | after | after | after |
| | Foam | after | after | after | exp. | exp. | exp. |
| Sample | Wt. | exp. | exp. | exp. | (% abs) | (% abs) | (% abs) |
| 1 | 153.4 | 206.2 | 197.6 | 193.9 | 34.42 | 28.81 | 26.40 |
| 3 | 153.4 | 184.9 | 176.8 | 174 | 20.53 | 15.25 | 13.43 |
| 4 | 142.8 | 180.8 | 174.3 | 171.2 | 26.61 | 22.06 | 19.89 |
| 5 | 154 | 186.6 | 178.3 | 175.4 | 21.17 | 15.79 | 13.90 |
| 6 | 150.1 | 179.3 | 171.2 | 167.6 | 19.45 | 14.06 | 11.66 |

The results for foam formula 3 are set forth in Table XXV, below:

TABLE XXV

| | Pre- | Wt. | Wt. | Wt. | | | |
|---|---|---|---|---|---|---|---|
| | exp. | (gms) | (gms) | (gms) | 0 hrs | 8 hrs | 24 hrs |
| | Foam | 0 hrs | 8 hrs | 24 hrs | after | after | after |
| | Wt. | after | after | after | exp. | exp. | exp. |
| Sample | (gms) | exp. | exp. | exp. | (% abs) | (% abs) | (% abs) |
| 1 | 145.5 | 236.3 | 223.9 | 216.4 | 62.41 | 53.88 | 48.73 |
| 2 | 143.9 | 241.5 | 229.5 | 222.2 | 67.82 | 59.49 | 54.20 |
| 3 | 145.1 | 184.7 | 173.5 | 168.9 | 27.29 | 19.57 | 16.40 |
| 4 | 146 | 183 | 170.2 | 165.1 | 25.34 | 16.58 | 13.08 |
| 5 | 156.3 | 234.9 | 220.8 | 213.9 | 50.29 | 41.27 | 36.85 |
| 6 | 139.9 | 211.5 | 198.9 | 193.9 | 51.18 | 42.17 | 38.60 |
| 7 | 138.9 | 177.1 | 166.9 | 163.7 | 27.50 | 20.16 | 17.85 |
| 8 | 138.2 | 185.3 | 174.4 | 169.7 | 34.08 | 26.19 | 22.79 |
| 9 | 138.0 | 170.4 | 160.7 | 156.8 | 23.48 | 16.45 | 13.62 |
| 10 | 138.6 | 176.5 | 165 | 161.3 | 27.34 | 19.05 | 16.38 |

The results for foam formula 4 are set forth in Table XXVI, below:

TABLE XXVI

| | Pre- | Wt. | Wt. | Wt. | | | |
|---|---|---|---|---|---|---|---|
| | exp. | (gms) | (gms) | (gms) | 0 hrs | 8 hrs | 24 hrs |
| | Foam | 0 hrs | 8 hrs | 24 hrs | after | after | after |
| | Wt. | after | after | after | exp. | exp. | exp. |
| Sample | (gms) | exp. | exp. | exp. | (% abs) | (% abs) | (% abs) |
| 1 | 149.9 | 208.8 | 197.8 | 191.6 | 39.29 | 31.95 | 27.82 |
| 2 | 150.7 | 235.4 | 225.3 | 218.3 | 56.20 | 49.50 | 44.92 |
| 3 | 150 | 222.5 | 211.6 | 204.6 | 48.33 | 41.07 | 36.40 |

The results for foam formula 5 are set forth in Table XXVII, below:

### Table XXVII

TABLE XXVII

| | Pre- | | | | | | |
|---|---|---|---|---|---|---|---|
| | exp. | | | | 0 hrs | 8 hrs | 24 hrs |
| | Foam | 0 hrs | 8 hrs | 24 hrs | after | after | after |
| | Wt. | after | after | after | exp. | exp. | exp. |
| Sample | (gms) | exp. | exp. | exp. | (% abs) | (% abs) | (% abs) |
| 1 | 123.4 | 212.9 | 201 | 194.4 | 72.53 | 62.88 | 57.54 |
| 2 | 122.7 | 194.4 | 182.4 | 175 | 58.44 | 48.66 | 42.62 |
| 3 | 119.4 | 207.4 | 197.6 | 191.4 | 73.70 | 65.49 | 60.30 |
| 4 | 123.3 | 186.1 | 174.8 | 168 | 50.93 | 41.77 | 36.25 |
| 5 | 120.8 | 189.1 | 179.1 | 172.2 | 56.54 | 48.26 | 42.55 |
| 6 | 126.7 | 197.3 | 185.7 | 178.5 | 55.72 | 46.57 | 40.88 |
| 7 | 123.8 | 204.9 | 194.1 | 186.7 | 65.51 | 56.79 | 50.81 |
| 8 | 122.2 | 208.1 | 198.2 | 191.7 | 70.29 | 62.19 | 56.87 |

The results for foam formula 6 are set forth in Table XXVIII, below:

TABLE XXVIII

| | Pre- | | | | |
|---|---|---|---|---|---|
| | exp. | 0 hrs | 4 hrs | 8 hrs | 24 hrs |
| | Foam | after | after | after | after |
| | Wt. | exp. | exp. | exp. | exp. |
| Sample | (gms) | (% abs) | (% abs) | (% abs) | (% abs) |
| 1 | 124.9 | 74.62 | 69.50 | 66.61 | 58.77 |
| 2 | 124.3 | 41.75 | 37.17 | 34.67 | 27.84 |
| 3 | 125.4 | 54.55 | 50.16 | 48.09 | 42.74 |
| 4 | 118.9 | 48.61 | 41.30 | 37.26 | 30.28 |
| 5 | 119.1 | 96.47 | 90.43 | 87.15 | 81.86 |
| 6 | 117.9 | 46.40 | 40.54 | 37.57 | 32.57 |
| 7 | 67.5 | 96 | 89.04 | 85.19 | 73.48 |
| 8 | 68.5 | 87.45 | 81.46 | 77.66 | 68.76 |
| 9 | 66 | 57.42 | 49.55 | 45.15 | 34.55 |

The results for foam formula 7 are set forth in Table XXIX, below:

TABLE XXIX

| | Pre-exp | 0 hrs after exposure | 24 hrs after |
|---|---|---|---|
| Sample | Foam wt. | (% abs) | exposure (% abs) |
| 1 | 125.5 | 27.81 | 14.26 |
| 2 | 129.3 | 24.13 | 10.75 |
| 3 | 126.9 | 30.81 | 16.94 |
| 4 | 125.2 | 30.35 | 17.57 |
| 5 | 122.6 | 28.55 | 15.82 |

Thus, as the results in Tables XXIII to XXIX indicate, the foam formulations of the present invention demonstrate enhanced hydrophobic (e.g., water repellent) characteristics and are especially suitable for applications requiring hydrophobic foams, including automotive applications requiring such types of foams.

The description of the invention is merely exemplary in nature and, thus, variations that do not depart from the gist of the invention are intended to be within the scope of the invention. Such variations are not to be regarded as a departure from the spirit and scope of the invention.

1. A method of making a rigid polyurethane foam, comprising mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains an isocyanate-terminated prepolymer made by reacting an excess of an organic polyisocyanate with (i) at least one polyol and (ii) at least one hydroxy-functional acrylate, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

2. The invention according to claim 1, wherein the polyurethane foam has a bulk density in the range of about 2 to about 40 pounds per cubic foot.

3. The invention according to claim 1, wherein the volume ratio of the polyisocyanate component to polyol component is about 1:1.

4. The invention according to claim 1, wherein the hydroxy-functional acrylate is a methacrylate.

5. The invention according to claim 1, wherein at least one polyol in the polyol component contains a tertiary amine group.

6. The invention according to claim 1, wherein the catalyst includes a reactive amine catalyst.

7. The invention according to claim 1, wherein the blowing agent is water or a chemical blowing agent that releases CO₂.

8. The invention according to claim 1, wherein the organic polyisocyanate is MDI or a polymeric MDI.

9. The invention according to claim 1, wherein the foam is formed into an automotive component.

10. A rigid polyurethane foam formed by mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains an isocyanate-terminated prepolymer made by reacting an excess of an organic polyisocyanate with (i) at least one polyol and (ii) at least one hydroxy-functional acrylate, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

11. The invention according to claim 10, wherein the polyurethane foam has a bulk density in the range of about 2 to about 40 pounds per cubic foot.

12. The invention according to claim 10, wherein the volume ratio of the polyisocyanate component to polyol component is about 1:1.

13. The invention according to claim 10, wherein the hydroxy-functional acrylate is a methacrylate.

14. The invention according to claim 10, wherein at least one polyol in the polyol component contains a tertiary amine group.

15. The invention according to claim 10, wherein the catalyst includes a reactive amine catalyst.

16. The invention according to claim 10, wherein the blowing agent is water or a chemical blowing agent that releases CO₂.

17. The invention according to claim 10, wherein the organic polyisocyanate is MDI or a polymeric MDI.

18. The invention according to claim 10, wherein the foam is formed into an automotive component.

19. A rigid polyurethane foam formed by mixing a polyisocyanate component with a polyol component in the presence of at least one catalyst for the reaction of a polyol or water with a polyisocyanate and subjecting the mixture to conditions sufficient to cure to form a polyurethane foam having a bulk density in the range of about 2 to about 40 pounds per cubic foot, wherein (a) the polyisocyanate component contains an isocyanate-terminated prepolymer made by reacting an excess of an organic polyisocyanate with (i) at least one polyol and (ii) at least one hydroxy-functional acrylate, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1, wherein the volume ratio of the polyisocyanate component to polyol component is about 1:1.

20. The invention according to claim 19, wherein the hydroxy-functional acrylate is a methacrylate.

21. The invention according to claim 19, wherein at least one polyol in the polyol component contains a tertiary amine group.

22. The invention according to claim 19, wherein the catalyst includes a reactive amine catalyst.

23. The invention according to claim 19, wherein the blowing agent is water or a chemical blowing agent that releases CO₂.

24. The invention according to claim 19, wherein the organic polyisocyanate is MDI or a polymeric MDI.

25. The invention according to claim 19, wherein the foam is formed into an automotive component.

26. A method of making a rigid polyurethane foam, comprising mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains at least one non-reactive hydrocarbon, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

27. The invention according to claim 26, wherein the non-reactive hydrocarbon is a paraffin-containing material.

28. The invention according to claim 26, wherein the non-reactive hydrocarbon is a chlorinated paraffin-containing material.

29. The invention according to claim 26, wherein the polyurethane foam has a bulk density in the range of about 2 to about 40 pounds per cubic foot.

30. The invention according to claim 26, wherein the volume ratio of the polyisocyanate component to polyol component is about 1:1.

31. The invention according to claim 26, wherein at least one polyol in the polyol component contains a tertiary amine group.

32. The invention according to claim 26, wherein the blowing agent is water or a chemical blowing agent that releases CO₂.

33. The invention according to claim 26, wherein the foam is formed into an automotive component.

34. A rigid polyurethane foam formed by mixing a polyisocyanate component with a polyol component in the presence of at least one catalyst for the reaction of a polyol or water with a polyisocyanate and subjecting the mixture to conditions sufficient to cure to form a polyurethane foam, wherein (a) the polyisocyanate component contains at least one non-reactive hydrocarbon, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1.

35. The invention according to claim 34, wherein the non-reactive hydrocarbon is a paraffin-containing material.

36. The invention according to claim 34, wherein the non-reactive hydrocarbon is a chlorinated paraffin-containing material.

37. The invention according to claim 34, wherein the polyurethane foam has a bulk density in the range of about 2 to about 40 pounds per cubic foot.

38. The invention according to claim 34, wherein the volume ratio of the polyisocyanate component to polyol component is about 1:1.

39. The invention according to claim 34, wherein at least one polyol in the polyol component contains a tertiary amine group.

40. The invention according to claim 34, wherein the blowing agent is water or a chemical blowing agent that releases CO₂.

41. The invention according to claim 34, wherein the foam is formed into an automotive component.

42. A rigid polyurethane foam formed by mixing a polyisocyanate component with a polyol component in the presence of at least one catalyst for the reaction of a polyol or water with a polyisocyanate and subjecting the mixture to conditions sufficient to cure to form a polyurethane foam having a bulk density in the range of about 2 to about 40 pounds per cubic foot, wherein (a) the polyisocyanate component contains at least one non-reactive hydrocarbon, (b) the polyol component contains an effective amount of a blowing agent and isocyanate-reactive materials that include at least one hydrophobic polyol selected from the group consisting of castor oil, soybean oil, and combinations thereof; and (c) the ratio of isocyanate groups in the polyisocyanate component to the number of isocyanate-reactive groups in the polyol component is less than 1:1, wherein the volume ratio of the polyisocyanate component to polyol component is about 1:1.

43. The invention according to claim 42, wherein the non-reactive hydrocarbon is a paraffin-containing material.

44. The invention according to claim 42, wherein the non-reactive hydrocarbon is a chlorinated paraffin-containing material.

45. The invention according to claim 42, wherein at least one polyol in the polyol component contains a tertiary amine group.

46. The invention according to claim 42, wherein the blowing agent is water or a chemical blowing agent that releases CO₂.

47. The invention according to claim 42, wherein the foam is formed into an automotive component.
